(19) United States
(12) Patent Application Publication
(10) Pub. No.: US 2014/0095029 A1
(43) Pub. Date: Apr. 3, 2014

(54) Sunroof Control Interface

(71) Applicant: TESLA MOTORS, INC., Palo Alto, CA (US)

(72) Inventors: Brennan Boblett, San Francisco, CA (US); Evan Small, Menlo Park, CA (US); Roy Goldman, Cupertino, CA (US); Joe Nuxoll, San Jose, CA (US)

(73) Assignee: Tesla Motors, Inc., Palo Alto, CA (US)

(21) Appl. No.: 13/849,747

(22) Filed: Mar. 25, 2013

Related U.S. Application Data
(60) Provisional application No. 61/706,915, filed on Sep. 28, 2012.

(51) Int. Cl. B60J 7/043; G06F 17/00

(52) U.S. Cl. CPC B60J 7/043; G06F 17/00
USPC 701/49

(57) ABSTRACT

A sunroof control interface, as well as a method of using the interface, is provided. The interface may use a visual representation of the vehicle's exterior and/or a slide controller to help the user to quickly identify the desired sunroof position. Assuming a touch-screen interface, the user can simply tap on the visual representation of the vehicle, or tap on the slide controller, to select the desired sunroof position. The desired sunroof position may also be selected using a mouse controller. The visual depiction of the vehicle may include a phantom sunroof overlay to further aid the user in selecting the desired sunroof position. A numerical indicator may be used with either the overlay or the slide controller to indicate the selected sunroof position relative to a fully open or fully closed sunroof.

### CROSS-REFERENCE TO RELATED APPLICATION

This application claims the benefit of the filing date of U.S. Provisional Patent Application Ser. No. 61/706,915, filed 28 Sep. 2012, the disclosure of which is incorporated herein by reference for any and all purposes.

### FIELD OF THE INVENTION

The present invention relates generally to a user interface and, more particularly, to a sunroof control interface that provides enhanced functionality utilizing a simplified controller and control methodology.

### BACKGROUND OF THE INVENTION

A conventional vehicle provides various interfaces that allow the user, i.e., the driver or passenger, a way of monitoring various vehicle conditions as well as controlling different vehicle functions. Depending upon the complexity of the systems to be monitored and/or controlled, such a user interface may utilize visual, tactile and/or audible feedback, and may be comprised of multiple interfaces, each interface grouping together those controls necessary to monitor and/or operate a specific vehicle subsystem (e.g., HVAC, entertainment/audio, navigation, etc.).

The user interface for the sunroof in a conventional vehicle typically includes a pair of buttons or similar means that are mounted in the vehicle's dash, ceiling, center console or door panel. One button acts to open the sunroof when pressed or otherwise activated, and the second button acts to close the sunroof when pressed or otherwise activated. In such a vehicle the sunroof moves, either opening or closing, for as long as the corresponding button is activated. Thus if the user wants to open the sunroof to the halfway open position, they depress the corresponding control button and hold the button in the depressed state until the sunroof appears to be approximately halfway open. When the sunroof reaches the desired location, the user releases the button. As a result of this configuration, in a conventional vehicle the user must release the steering wheel with one hand and depress the appropriate sunroof control button until the sunroof reaches the desired location, an action which is not only distracting and inconvenient, but also provides the user with an inaccurate method of controlling the actual position of the sunroof. Accordingly, what is needed is a sunroof controller that minimizes driver distraction while achieving a greater level of sunroof control. The present invention provides such a sunroof control interface.

### SUMMARY OF THE INVENTION

A method for positioning a sunroof is provided, the method including the steps of (i) providing a GUI display within a vehicle's passenger compartment; (ii) displaying a sunroof GUI control screen on the GUI display; (iii) displaying a sunroof control interface on the sunroof GUI control screen, where the sunroof control interface provides control over the vehicle's sunroof; (iv) accepting a user selection of a desired sunroof position via the sunroof control interface; and (v) positioning the sunroof to a sunroof position that corresponds to the desired sunroof position, where the positioning step is performed automatically in response to the user selection of the desired sunroof position, and where the step of positioning the sunroof is completed after the step of accepting the user selection.

In one aspect, a visual representation of the vehicle, for example a photorealistic depiction of the vehicle, is displayed on the sunroof control interface. The visual representation of the vehicle may include a sunroof overlay, for example positioned at an overlay position that corresponds to the actual sunroof position. The GUI display may be a touch-screen and the method may further include the steps of (i) accepting a tap on the visual representation of the vehicle at a location corresponding to the desired sunroof position, (ii) positioning the sunroof overlay at the desired sunroof position on the visual representation of the vehicle, and (iii) providing a numerical indicator on the sunroof overlay that is representative of the desired sunroof position relative to either a fully open or fully closed sunroof. Alternately, the method may include the steps of (i) allowing placement of a cursor on the visual representation of the vehicle at a location corresponding to the desired sunroof position, (ii) accepting selection of the desired sunroof position using a mouse controller button, (iii) positioning the sunroof overlay at the desired sunroof position on the visual representation of the vehicle, and (iv) providing a numerical indicator on the sunroof overlay that is representative of the desired sunroof position relative to either a fully open or fully closed sunroof.

In another aspect, a slide controller is displayed on the sunroof control interface. The GUI display may be a touch-screen and the method may further include the steps of (i) accepting a tap at a location on the slide controller corresponding to the desired sunroof position, (ii) positioning a button on the slide controller at the desired sunroof position, and (iii) associating a numerical indicator with the button that is representative of the desired sunroof position relative to either a fully open or fully closed sunroof. Alternately, the method may include the steps of (i) allowing placement of a cursor on the slide controller at a location corresponding to the desired sunroof position, (ii) accepting selection of the desired sunroof position using a mouse controller button, (iii) positioning a button on the slide controller at the desired sunroof position, and (iv) associating a numerical indicator with the button that is representative of the desired sunroof position relative to either a fully open or fully closed sunroof.

In another aspect, a sunroof control interface is provided that includes (i) a vehicle sunroof, (ii) a GUI display mounted within the vehicle, (iii) a sunroof interface displayed on the GUI display that is comprised of a plurality of discrete and user selectable regions, where each region corresponds to one of a plurality of sunroof positions, and (iv) a system controller, where whenever one of the regions is selected the system controller is configured to match a location corresponding to the selected region with one of the sunroof positions and automatically adjust the sunroof to that sunroof position. A visual representation of the vehicle may be displayed on the sunroof interface, where the selected region may be selected via a tap on a touch-screen GUI display, or selected using a cursor and a mouse controller, after which the system controller may be configured to reposition the sunroof overlay to the selected region on the visual representation of the vehicle. A slide controller may be displayed on the sunroof interface, where the selected region may be selected via a tap on a touch-screen GUI display, or selected using a cursor and a mouse controller, after which the system controller may be configured to position a button on the slide controller that corresponds to the selected region.

A further understanding of the nature and advantages of the present invention may be realized by reference to the remaining portions of the specification and the drawings.

### BRIEF DESCRIPTION OF THE DRAWINGS

FIG. 1 provides a block diagram of an exemplary interface system that may be used with the present invention;

FIG. 2 illustrates an exemplary sunroof control screen;

FIG. 3 illustrates the exemplary GUI screen of FIG. 2 with the user interacting with the depiction of the sunroof and its position relative to the vehicle;

FIG. 4 illustrates the exemplary GUI screen of FIG. 2 with the user interacting with the sunroof slide controller;

FIG. 5 illustrates the exemplary GUI screen of FIG. 2 after the user's interactions via either the sunroof overlay (FIG. 3) or the slide controller (FIG. 4);

FIG. 6 illustrates the exemplary GUI screen of FIG. 2 with the user employing a touch-and-slide interaction technique with the sunroof overlay controller;

FIG. 7 illustrates the exemplary GUI screen of FIG. 2 with the user employing a touch-and-slide interaction technique with the slide controller;

FIG. 8 illustrates the exemplary GUI screen of FIG. 2 after the user's interactions via either the sunroof overlay (FIG. 6) or the slide controller (FIG. 7);

FIG. 9 illustrates the exemplary GUI screen of FIG. 2 modified to include multiple presets;

FIG. 10 illustrates the exemplary GUI screen of FIG. 9 using a different technique for highlighting presets;

FIG. 11 illustrates the exemplary GUI screen of FIG. 10, this view showing the regions on the slide controller and vehicle depiction associated with each of the presets; and

FIG. 12 illustrates the exemplary GUI screen of FIGS. 10 and 11 after a user has selected one of the presets.

### DESCRIPTION OF THE SPECIFIC EMBODIMENTS

The preferred embodiment of the present invention utilizes a large format touch-screen, both as a visual aid and as a means of controlling various vehicle subsystems including the sunroof. The inventors also envision that the invention may be used with a non-touch-screen display along with an input device such as a mouse controller, although such an approach is less intuitive. In at least one embodiment, the display is a 17-inch touch-screen with a 16:10 aspect ratio. Due to its size as well as the limitations on available mounting space in a typical vehicle, preferably this touch-screen is mounted in portrait mode within the vehicle's central console. Besides being aesthetically pleasing, such a mounting location provides access to the data on the screen as well as the displayed system controls to both the driver and the passenger seated in the passenger front seat.

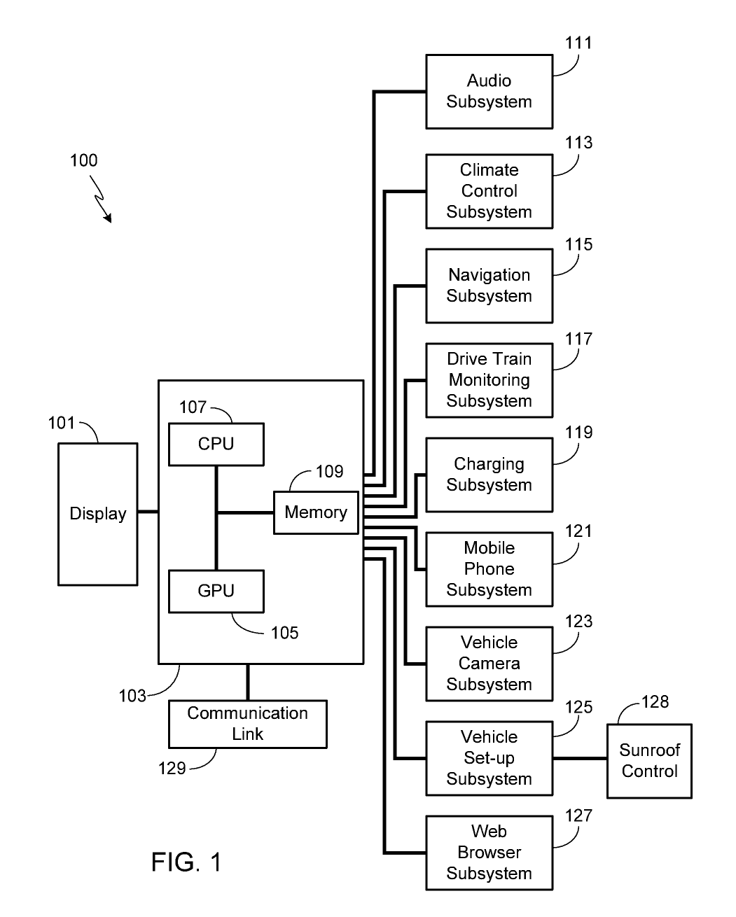

FIG. 1 provides a block diagram of an exemplary interface system 100 that includes touch-screen 101 and is suitable for use with the invention. In system 100, display 101 is coupled to a system controller 103. Controller 103 includes a graphical processing unit (GPU) 105, a central processing unit (CPU) 107, and memory 109. CPU 107 and GPU 105 may be separate or contained on a single chip set. Memory 109 may be comprised of flash memory, a solid state disk drive, a hard disk drive, or any other memory type or combination of memory types. Controller 103 is coupled to a variety of different vehicle subsystems, including the vehicle subsystem controls and vehicle subsystem monitors that are to be accessed and/or viewed on display 101. Exemplary subsystems include audio subsystem 111, climate control subsystem 113, navigation subsystem 115, drive train monitoring subsystem 117, charging subsystem 119, mobile phone subsystem 121, vehicle camera subsystem 123, vehicle set-up subsystem 125 and web browser subsystem 127. Vehicle set-up subsystem 125 allows general vehicle operating conditions to be set, conditions such as sun roof operational control 128 as well as seat position, internal and external lighting, windshield wiper operation, etc. Preferably a mobile telecommunications link 129 is also coupled to controller 103, thereby allowing the controller to obtain updates, interface configuration profiles, and other data from an external data source (e.g., manufacturer, dealer, service center, web-based application, remote home-based system, etc.). Mobile telecommunications link 129 may be based on any of a variety of different standards including, but not limited to, GSM EDGE, UMTS, CDMA2000, DECT, and WiMAX.

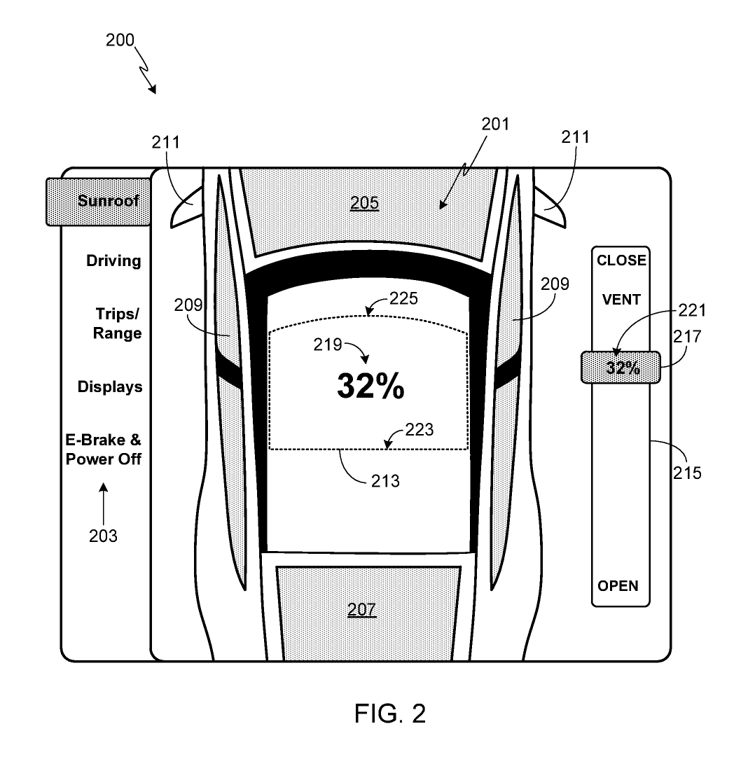

In the preferred embodiment, and as described below in detail, interface system 100 allows the user to position the sunroof in a variety of ways. FIG. 2 provides an exemplary sunroof user control interface screen 200. It should be understood that the icons and information shown on this and subsequent graphical user interface (GUI) screens is for illustration purposes only and that the invention is equally applicable to interface screens utilizing a different format, size or configuration as well as interfaces utilizing different operating systems, different programs/applications, etc. In the embodiments illustrated in FIGS. 2-12, the sunroof control interface 200 is one of a number of vehicle set-up control screens accessed via system 100 in general, and vehicle set-up subsystem 125 in particular. In the illustrated embodiments, other aspects of the vehicle may be accessed by selecting from the feature sets shown in the left-hand portion 203 of screen 200; note that the sunroof soft-button 205 is highlighted, showing that this feature set has been selected.

In accordance with at least one embodiment of the invention, the sunroof control screens include a visual representation of the vehicle, and more preferably an exterior, top-down visual representation of the vehicle, e.g., representation 201 shown in FIG. 2. Preferably the representation of the vehicle is photorealistic, i.e., a graphical representation that appears to be photographic. Providing the user with an accurate depiction of the vehicle, and more particularly the sunroof section of the same model of vehicle being controlled via the control screen, helps the user quickly and correctly identify the desired settings for the sunroof. In the view provided in FIG. 2, numerous vehicle features are shown that help orient the user, features such as the front windshield 205, rear window 207, side windows 209, side view mirrors 211, etc.

In the preferred and illustrated sunroof control interface GUI screen 200, the location of the sunroof is indicated on the screen in two ways, both of which provide a means of controlling the position of the sunroof as well as a means of determining the present position of the sunroof. First, the sunroof is shown in phantom as an overlay 213 on vehicle representation 201. Second, a slider control 215 is provided in which soft button 217 represents the position of the sunroof. Accordingly, when the position of the sunroof has changed, the position of phantom overlay 213 relative to vehicle representation 201 changes as does the position of slider soft button 217. As a result, the user is given a visual indicator of the position of the sunroof. In at least one preferred embodiment in addition to providing visual indicators of roof position, numerical indicators are provided that express the amount (e.g., percentage) that the sunroof is open or closed. In the illustrated embodiment, 0% represents a closed sunroof and 100% represents a fully open sunroof, although clearly these two values could be reversed, i.e., 0% representing a fully open sunroof and 100% representing a closed sunroof. As shown, sunroof overlay 213 includes numerical indicator 219 while a second numerical indicator 221 is provided on slider button 217, both of which indicate that in the exemplary screen the sunroof is currently open to 32% of the maximum possible opening.

In at least one embodiment of the invention, in order to alter the position of the sunroof the user can tap, or otherwise select (e.g., using a mouse controller), the desired location of the sunroof on vehicle representation 201. The system can also be configured to allow the user to tap, or otherwise select (e.g., using a mouse controller), the desired sunroof location on slider controller 215. When the user selects the desired sunroof location by either tapping on the vehicle image 201 or the slider controller 215, the sunroof immediately begins to move to the indicated position. Sunroof movement continues to the indicated position even though the user does not continue to indicate the desired sunroof position, either via image 201 or slider 215. Thus in contrast to a conventional sunroof interface that requires that the user continuously depress a sunroof control button as long as sunroof movement is desired, the present invention allows the user to quickly and simply indicate the desired final sunroof position with a single tap of the touch-screen, or with a single selection using a mouse controller. By requiring only a single interaction rather than a continuous engagement of the sunroof controller, the user is free to focus on driving the vehicle.

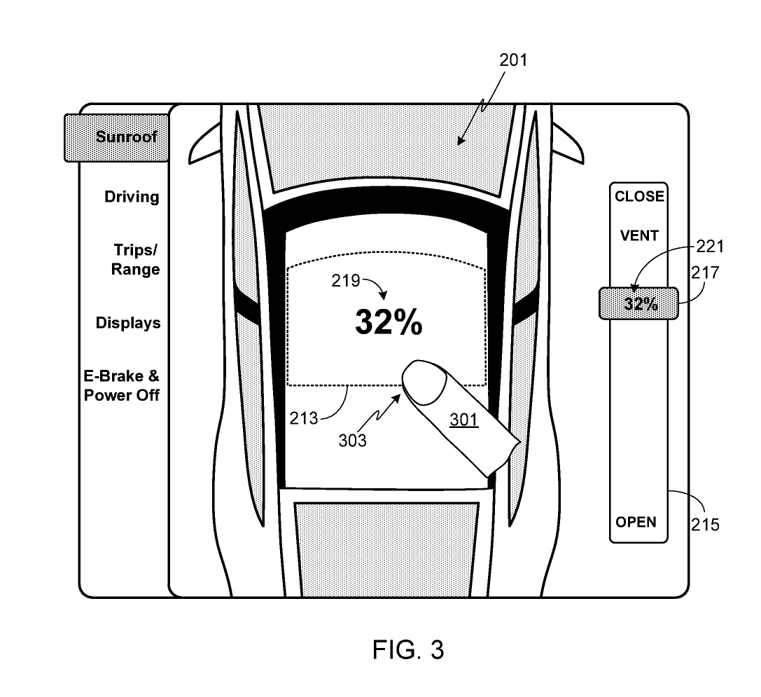

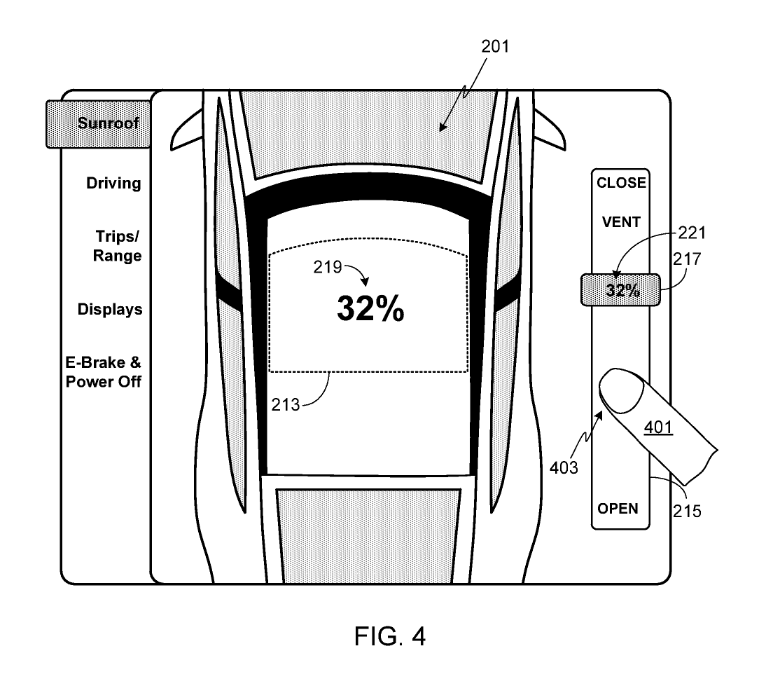

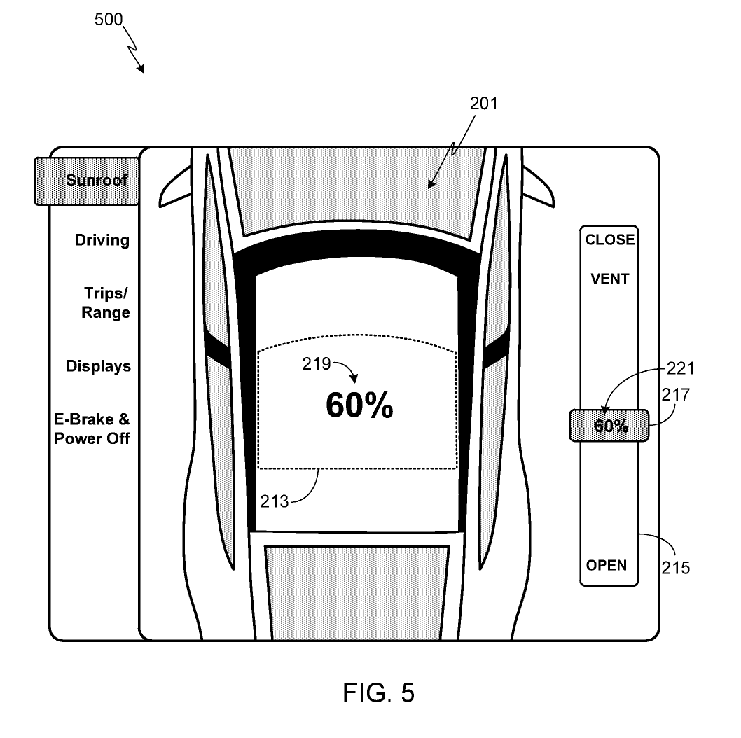

FIG. 3 illustrates a user 301 tapping on vehicle representation 201 at a location 303 while FIG. 4 illustrates a user 401 tapping on slide controller location 403, both of which initiate sunroof movement from its previous location, i.e., the sunroof's location prior to the user indicating the new desired location by interacting with the touch-screen GUI interface 200. In this embodiment, once the user has indicated the desired sunroof position via tapping on the touch-screen, the sunroof moves to the desired position with the new position being indicated on the GUI interface. For example, assuming that the previous sunroof location was that shown in FIGS. 2-4, and that the user selected a 60% opening, either via the user interaction shown in FIG. 3 or the user interaction shown in FIG. 4, then upon completion of sunroof repositioning the GUI interface would look like screen 500 shown in FIG. 5. Note that the sunroof is shown as being 60% open, i.e., sunroof phantom 213 on the vehicle depiction has moved to the 60% position, soft button 217 has moved to the 60% position on the slide control 215, and numerical indicators 219 and 221 both indicate a 60% opening.

In the embodiment described above, the user selects a sunroof position by tapping, or otherwise selecting, the desired sunroof location, either on vehicle depiction 201 or slide controller 215. In the preferred embodiment, system controller 103 aligns the touch location on vehicle depiction 201 (e.g., location 303 in FIG. 3) with the middle of the sunroof, and aligns the touch location on slide controller 215 (e.g., location 403 in FIG. 4) with the middle of button 217. This alignment allows the controller to determine the desired sunroof location from the location of the user's touch on the sunroof control interface screen (e.g., screen 200). It should be understood, however, that controller 103 can be configured to align other aspects of the sunroof with the user's touch. For example, controller 103 can be configured to align an edge of the sunroof with the user's touch, e.g., rear edge 223 or front edge 225 of the phantom sunroof may be aligned with the location of the user's touch on the GUI interface screen. Similarly, an edge or other region of button 217 may be aligned with the user's touch on slide controller 215.

In at least one embodiment of the invention, in order to alter the position of the sunroof a select-and-slide interface interaction technique is used to move the sunroof to the desired location, for example using a touch-and-slide motion with sunroof overlay 213 or with button 217 on slide controller 215. In this approach the user touches, or otherwise selects, sunroof overlay 213 and then slides the sunroof to the desired location on vehicle depiction 201. Alternately the user can touch, or otherwise select, button 217 and then slide the button to the desired location on slide controller 215. During this motion overlay 213, and/or button 217, moves at the same rate as the user's finger or at the same rate as a cursor if a mouse controller is used. Once the user has moved overlay 213, or button 217, to the desired location, they release their finger from the touch-screen, or deselect (e.g., unclick) the selection button on the mouse controller, thus indicating to controller 103 that a final sunroof destination has been selected. Preferably the sunroof begins to move as soon as the user alters the position of overlay 213 or button 217. Alternately, the system can be configured to only begin moving the sunroof after the user has selected the desired sunroof position and released their finger from the touch-screen, or selected the desired sunroof position and unclicked the mouse controller. Regardless of whether sunroof motion begins when the user initiates the touch-and-slide motion, or after completion of the touch-and-slide motion, sunroof movement continues to the indicated final position after the user has completed the touch-and-slide motion. Therefore as with the prior embodiment, the user is able to quickly indicate the desired final sunroof position without requiring continuous engagement of the sunroof controller, thus allowing the user to focus on driving the vehicle.

In the above embodiment in which a touch-and-slide or click-and-slide motion is used with either overlay 213 or button 217, the overlay/button are preferably configured to track the user's motion as the user adjusts overlay 213 or button 217, thereby providing the user with a visual indicator of the expected final position of the sunroof. Additionally, in at least one preferred embodiment, numerical indicators 219 and 221 also continuously vary from the initial sunroof setting to the final sunroof setting as the user slides the overlay/button, thus providing a secondary indicator of the sunroof position.

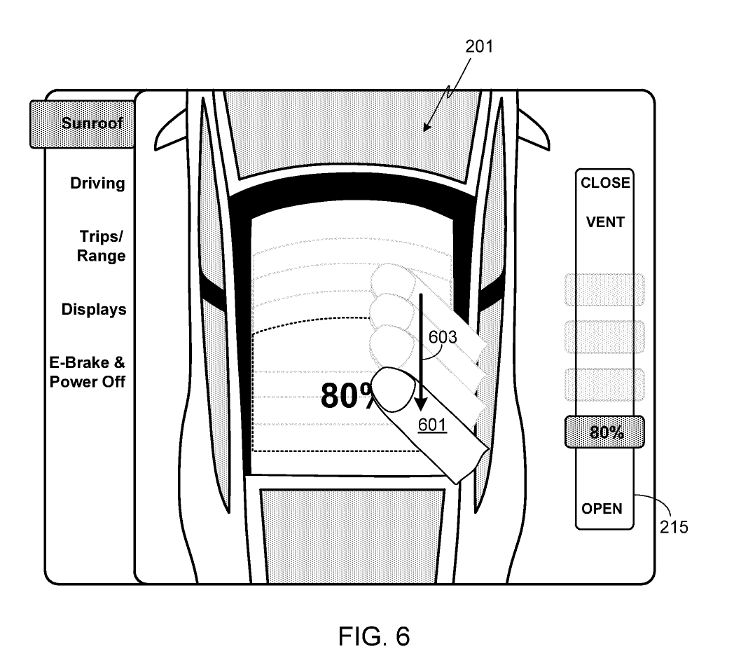

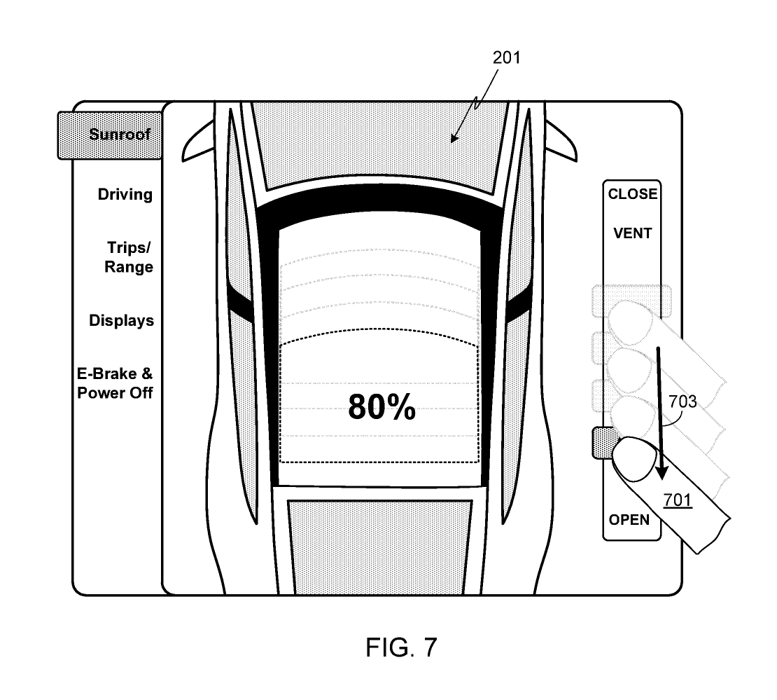

FIG. 6 illustrates a user 601 employing the touch-and-slide method to move overlay 213 from an initial position of 32% open to a final position of 80% open. Similarly, FIG. 7 illustrates a user 701 employing the touch-and-slide method to move button 217 from an initial position of 32% open to a final position of 80% open. To indicate overlay/button motion, several intermediate overlay/button positions are shown on FIGS. 6 and 7 as well as arrows 603/703 that indicate the direction of user motion. It should be understood that these intermediate screens and arrows 603/703 are only shown to illustrate motion and in actual use the motion includes a large number of intermediate positions so that the overlay's motion as well as the button's motion appears continuous to the user during the user's entire touch-and-slide interaction with the sunroof control interface.

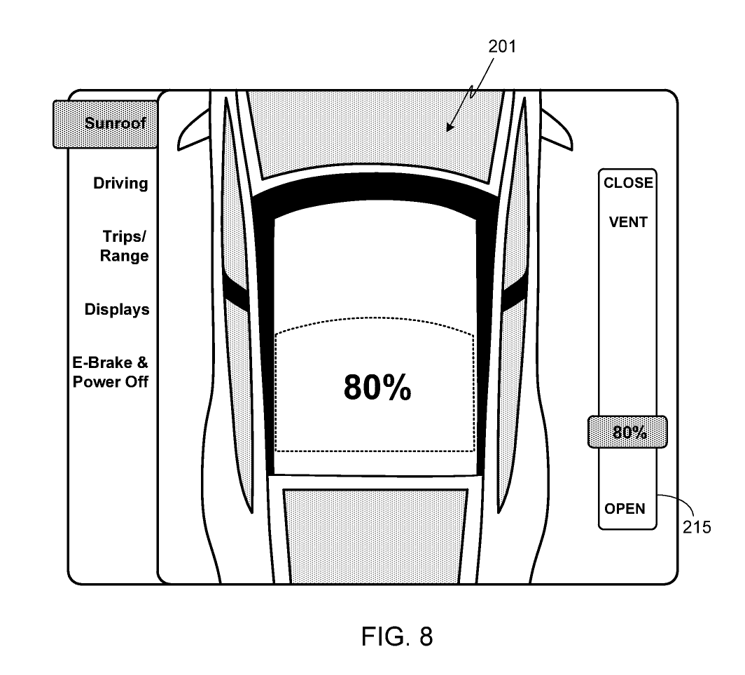

Additionally, it should be understood that in a GUI interface that utilizes both the overlay and the slide controller as shown in FIGS. 6 and 7, as the user moves one sunroof controller, the secondary sunroof controller simultaneously moves. Thus as user 601 moves overlay 213, button 217 moves as well. Similarly, as user 701 moves button 217, overlay 213 moves. FIG. 8 illustrates the sunroof control interface screen after completion of sunroof repositioning in accordance with either FIG. 6 or 7.

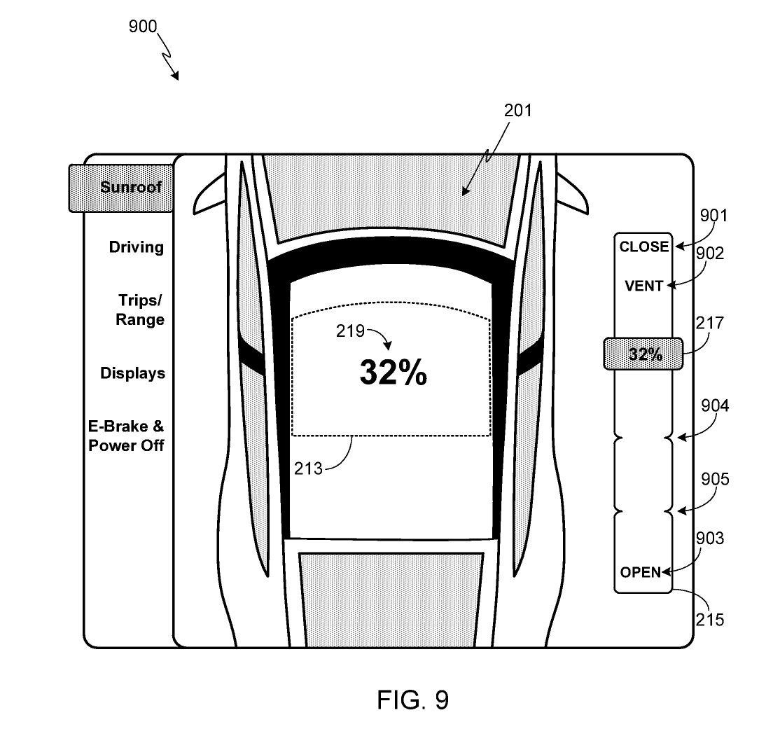

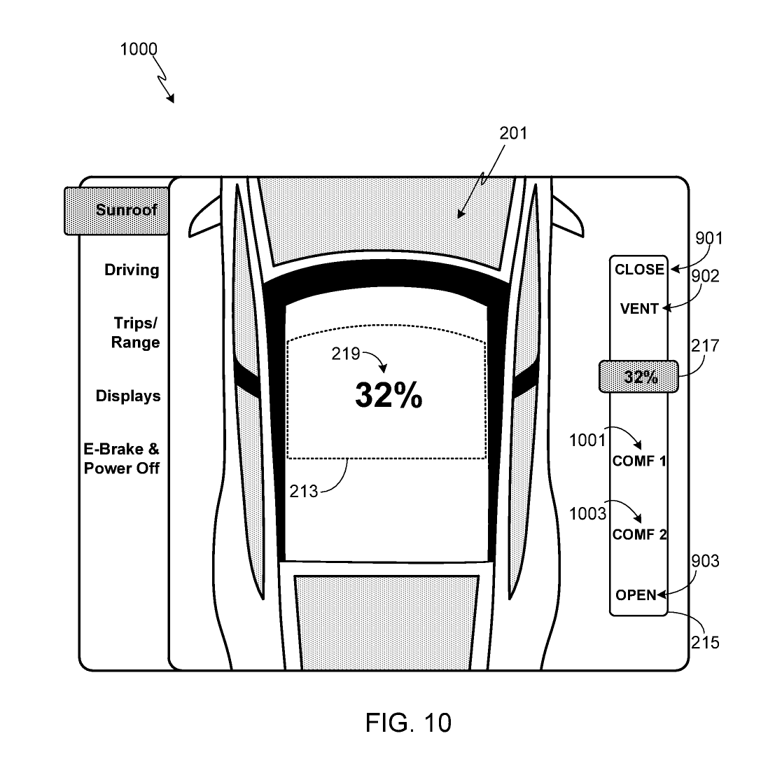

In at least one embodiment of the invention, the sunroof controller includes one or more presets, each of which corresponds to a specific sunroof position. For example, in the sunroof GUI interface screen 900 shown in FIG. 9 five such presets are included: close, vent, comfort 1, comfort 2, and open. In screen 900 three of the settings, i.e., close, vent and open, are provided with descriptive labels 901-903, respectively, on slide controller 215. In screen 900 the two comfort settings are highlighted on the slide controller with indentations 904 and 905, although other means may be used to label or otherwise highlight the presets. For example, screen 1000 shown in FIG. 10 includes labels 1001 and 1003 for the two comfort settings. It will be understood that a fewer number, or a greater number, of presets than those shown in FIGS. 9 and 10 may be employed by the sunroof controller of the invention. The presets may be set-up by the end user, thus allowing the user to configure the sunroof in accordance with personal preferences. Alternately, the presets may be set-up by the vehicle's manufacturer or a third party, thus allowing the presets to be based on any number of desirable characteristics, e.g., a ‘typical’ user preference, minimization of wind noise, etc.

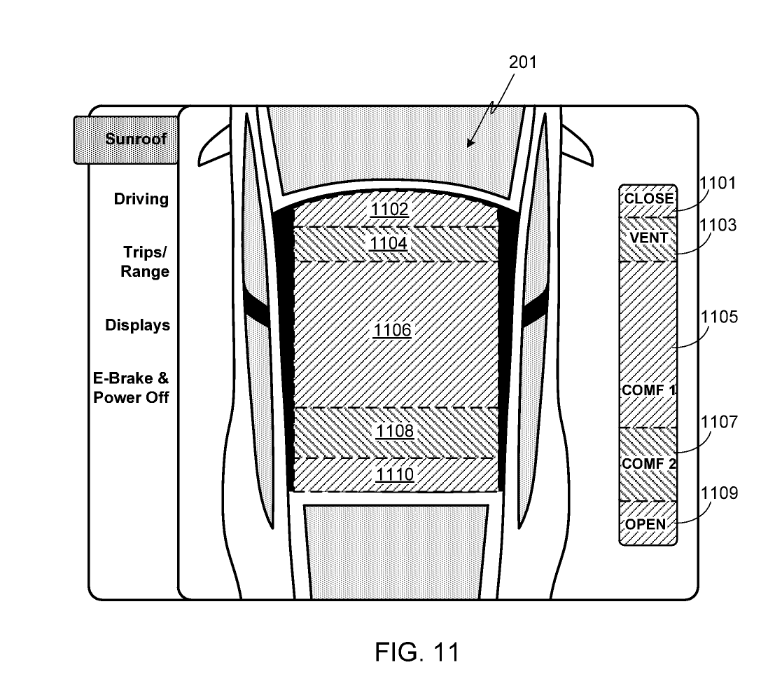

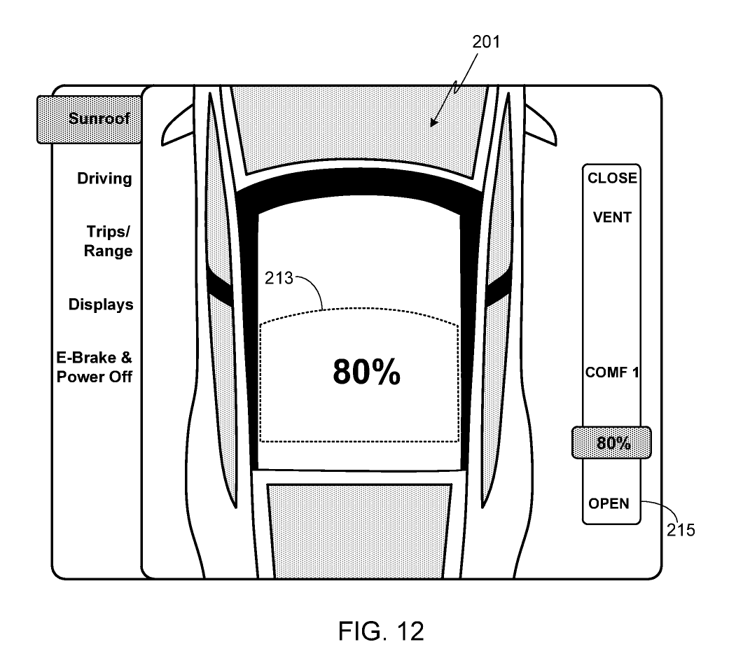

The sunroof controller of the invention can be configured to utilize the previously described presets in a variety of ways. In one configuration, the user is only able to move the sunroof to a preset location. Although this configuration prevents the user from making small adjustments to the sunroof's position, it simplifies user interaction which, in turn, minimizes driver distractions. In this configuration the user taps, or otherwise selects, a location on either vehicle depiction 201 or slide controller 215. Controller 103 determines the intended preset based on the location of the tap/selection and then moves the sunroof to the position corresponding to the selected preset. FIG. 11 illustrates the boundaries used by controller 103 to determine the intended preset in accordance with one embodiment. In this configuration the controller associates a user touch/selection of slide controller 215 within region 1101, or a user touch/selection of vehicle depiction 201 within region 1102, with a command to close the sunroof. Similarly, the controller associates a user touch/selection of slide controller 215 within region 1103, or a user touch/selection of vehicle depiction 201 within region 1104, with a command to open the sunroof to the vent position; associates a user touch/selection of slide controller 215 within region 1105, or a user touch/selection of vehicle depiction 201 within region 1106, with a command to open the sunroof to the first comfort preset; associates a user touch/selection of slide controller 215 within region 1107, or a user touch/selection of vehicle depiction 201 within region 1108, with a command to open the sunroof to the second comfort preset; and associates a user touch/selection of slide controller 215 within region 1109, or a user touch/selection of vehicle depiction 201 within region 1110, with a command to open the sunroof to the fully open position. FIG. 12 illustrates the sunroof interface screen after a user has either touched region 1108 of vehicle depiction 201, or touched region 1107 of slide controller 215.

While the configuration described above simplifies sunroof operation, in the preferred embodiment the system allows the use of presets and provides the user with means for positioning the sunroof at a location other than that corresponding to a preset. The inventors envision that the system can be configured to use a variety of different combinations of presets and other input techniques. For example:
In one specific embodiment, if the user taps, or otherwise selects a region on vehicle depiction 201 or slide controller 215, the controller determines the corresponding preset and moves the sunroof to that location. If, however, the user wishes to move the sunroof to a non-preset location, they can use the touch-and-slide, or select-and-slide, technique with either overlay 213 or button 217 as described above.
In an alternate embodiment, if the user taps, or otherwise selects a region (e.g., clicks with a mouse controller) on vehicle depiction 201 or slide controller 215, the controller determines the corresponding preset and moves the sunroof to that location. If, however, the user wishes to move the sunroof to a non-preset location, they can double tap, or double click, a location on either vehicle depiction 201 or slide controller 215, thereby causing the controller to move the sunroof to the designated position. Controller 103 distinguishes between taps and double taps, or clicks and double clicks, based on the time interval between taps/clicks. The time interval used to distinguish between these types of user interactions may be preset, for example by the vehicle's manufacturer, or configured by the end-user.
In an alternate embodiment, if the user double taps or double clicks a region on vehicle depiction 201 or slide controller 215, the controller determines the corresponding preset and moves the sunroof to that location. If, however, the user wishes to move the sunroof to a non-preset location, they simply tap or click (i.e., select) a location on either vehicle depiction 201 or slide controller 215, thereby causing the controller to move the sunroof to the designated position. Controller 103 distinguishes between taps and double taps, or clicks and double clicks, based on the time interval between taps/clicks. The time interval used to distinguish between these types of user interactions may be preset, for example by the vehicle's manufacturer, or configured by the end-user.
In an alternate embodiment, slide controller 215 is used with the presets while the vehicle depiction 201 is used if the user wishes to move the sunroof to a non-preset location. In this embodiment the user can use either the tapping or tap-and-slide approach with overlay 213 to position the sunroof in a particular location. In order to move to a preset location, the user simply taps slide controller 215 as described above, causing controller 103 to determine the corresponding preset based on tap location.
In an alternate embodiment, vehicle depiction 201 is used with the presets while the slide controller 215 is used if the user wishes to move the sunroof to a non-preset location. In this embodiment the user can use either the tapping or tap-and-slide approach with button 217 and slide controller 215 to position the sunroof in a particular location. In order to move to a preset location, the user simply taps vehicle depiction 201 as described above, causing controller 103 to determine the corresponding preset based on tap location and the indicated region of the vehicle depiction.

It should be understood that identical element symbols used on multiple figures refer to the same component, or components of equal functionality. Additionally, the accompanying figures are only meant to illustrate, not limit, the scope of the invention and should not be considered to be to scale.

Systems and methods have been described in general terms as an aid to understanding details of the invention. In some instances, well-known structures, materials, and/or operations have not been specifically shown or described in detail to avoid obscuring aspects of the invention. In other instances, specific details have been given in order to provide a thorough understanding of the invention. One skilled in the relevant art will recognize that the invention may be embodied in other specific forms, for example to adapt to a particular system or apparatus or situation or material or component, without departing from the spirit or essential characteristics thereof. Therefore the disclosures and descriptions herein are intended to be illustrative, but not limiting, of the scope of the invention. Claims: A method of controlling operation of a vehicle sunroof, the method comprising the steps of:

1. A method of positioning a sunroof, the method comprising the steps of:
providing a touchscreen graphical user interface (GUI) display within a vehicle passenger compartment of a vehicle;
displaying a sunroof GUI control screen on said touchscreen GUI display;
displaying first and second sunroof controls on said sunroof GUI control screen, said first and second sunroof controls providing control over said sunroof integrated within said vehicle;
wherein the first sunroof control comprises a photorealistic visual representation of the vehicle presenting a sunroof overlay in each successive location from an open position to a closed position, the first sunroof control configured to (i) allow a user to input a desired sunroof position by sliding the sunroof overlay to any of the successive locations on the photorealistic visual representation of the vehicle, and (ii) allow the user to input the desired sunroof position by tapping at any of the successive locations;
wherein the second sunroof control comprises a slide controller configured to (i) allow the user to input the desired sunroof position by sliding a slider to a position corresponding to any of the successive locations, and (ii) allow the user to input the desired sunroof position by tapping at any position on the slide controller;
accepting a user selection of the desired sunroof position is made by the user with one of the first and second sunroof controls of said sunroof GUI control screen;
in response to the user selection, updating another of the first and second sunroof controls to reflect the desired sunroof position; and
positioning said sunroof to a sunroof position corresponding to said desired sunroof position, wherein said positioning step is initiated automatically in response to said step of accepting said user selection of said desired sunroof position and continues until the sunroof reaches the desired sunroof position even though the user does not continue to indicate the desired sunroof position, and wherein said step of positioning said sunroof to said sunroof position is completed after said step of accepting said user selection is completed.

2. (canceled)

3. (canceled)

4. (canceled)

5. (canceled)

6. (canceled)

7. The method of claim 1, further comprising the step of providing a numerical indicator on said sunroof overlay and on said slide controller, the numerical indicator representing said desired sunroof position relative to a fully open sunroof position.

8. The method of claim 1, further comprising the step of providing a numerical indicator on said sunroof overlay and on said slide controller, the numerical indicator representing said desired sunroof position relative to a fully closed sunroof position.

9. The method of claim 1, wherein said step of accepting said user selection of said desired sunroof position further comprises the steps of allowing placement of a cursor on said visual representation of said vehicle at said desired sunroof position using a mouse controller and accepting selection of said desired sunroof position using a mouse controller button, wherein said step of positioning said sunroof to said sunroof position is performed after said step of accepting selection of said desired sunroof position using said mouse controller button.

10. (canceled)

11. (canceled)

12. (canceled)

13. (canceled)

14. (canceled)

15. (canceled)

16. The method of claim 7, wherein the numerical indicator on said slide controller is provided on the slider.

17. The method of claim 8, wherein the numerical indicator on said slide controller is provided on the slider.

18. (canceled)

19. (canceled)

20. (canceled)

21. (canceled)

22. A sunroof control interface, comprising:
a sunroof integrated into a vehicle;
a touchscreen graphical user interface (GUI) display mounted within a vehicle passenger compartment of said vehicle;
a sunroof GUI control screen displayed on said touchscreen GUI display;
first and second sunroof controls displayed on said sunroof GUI control screen, said first and second sunroof controls providing control over said sunroof integrated within said vehicle;
wherein the first sunroof control comprises a photorealistic visual representation of the vehicle presenting a sunroof overlay in each successive location from an open position to a closed position, the first sunroof control configured to (i) allow a user to input a desired sunroof position by sliding the sunroof overlay to any of the successive locations on the photorealistic visual representation of the vehicle, and (ii) allow the user to input the desired sunroof position by tapping at any of the successive locations:
wherein the second sunroof control comprises a slide controller configured to (i) allow the user to input the desired sunroof position by sliding a slider to a position corresponding to any of the successive locations, and (ii) allow the user to input the desired sunroof position by tapping at any position on the slide controller; and
a system controller coupled to said sunroof interface and to said sunroof, wherein whenever the desired sunroof position is selected by the user with one of the first and second sunroof controls, said system controller is configured to update another of the first and second sunroof controls to reflect the desired sunroof position, said system controller further configured to automatically adjust said sunroof to said one of said plurality of sunroof positions after said region is selected, said automatic adjustment initiated automatically in response to user selection of said desired sunroof position and continuing until the sunroof reaches the desired sunroof position even though the user does not continue to indicate the desired sunroof position.

23. (canceled)

24. (canceled)

25. (canceled)

26. (canceled)

27. (canceled)

28. (canceled)

29. (canceled)

30. (canceled)
